(19) United States
(12) Patent Application Publication
(10) Pub. No.: US 2002/0112580 A1
(43) Pub. Date: Aug. 22, 2002

(54) Sliding jogger and a blanking tool incorporating such jogger

(76) Inventors: Joseph McArdle, Drogheda (IE); Sean MacEntee, Bettystown Cross (IE); Brendan McCann, Celbridge (IE)

Correspondence Address: Porter, Wright, Morris & Arthur LLP, ATTN: Intellectual Property Department, 28th Floor, 41 South High Street, Columbus, OH, 43215-6194, US

(21) Appl. No.: 10/045,630

(22) Filed: Oct. 26, 2001

(30) Foreign Application Priority Data
Nov. 1, 2000 (IE) S2000/0877

(51) Int. Cl. B26D 7/06

(52) U.S. Cl. 83/86; 83/696; 493/417

(57) ABSTRACT

A sliding jogger comprising a fixed part 10 for securing to the frame 16 of a blanking tool and a sliding part 12 slidable on the fixed part. The two parts of the jogger are formed by stamping a respective blank from sheet metal and bending the blank.

This invention relates to a sliding jogger and a blanking tool incorporating such jogger.

“Jogging” is a term long used in the printing/packaging industry to describe the action of lining-up sheets of paper or cardboard. This is generally carried out while the sheets are dropped singly onto pallets, for example from the end of a blanking tool (blanking tools are used to separate individual shapes from a cardboard sheet, the shapes having been stamped into the cardboard sheet but still being attached to each other and to the outside frame of the cardboard sheet by attachment points created by placing small gaps in the cutting edges of the knives used to cut the shapes from the cardboard sheets). The normal occurrence is for metal guides to move (jog) by an oscillating movement from opposite directions and consequently guide the sheets neatly in line as they form a stack. These metal guides are known as joggers.

In the manufacture of blanking tools, two types of joggers are used. One, known as a “fixed” jogger, is typically a simple, flat piece of steel welded into position on the internal section of the blanking tool. The other, known as a “sliding” jogger, comprises two parts—one (the fixed part) being fixed to a profiled support bar, the other (the slidable part) being slidably mounted on the fixed part in order to extend the length of the jogger while the changeover of full to empty pallets is taking place on the machine. The sliding jogger is fitted to the outer support frame of the tool.

Existing sliding joggers are manufactured by machining the two parts from solid steel or brass to a precise degree in order to fit properly and avoid jamming during the sliding action. The amount of machining involved results in a high component cost. We have found that the greatest individual material cost in a blanking tool is generally the sliding jogger content.

Accordingly, the present invention provides a sliding jogger comprising a fixed part for securing to the frame of a blanking tool and a sliding part slidable on the fixed part, wherein the two parts of the jogger are formed by stamping a respective blank from sheet metal and bending the blank.

A further disadvantage of existing designs of sliding joggers is the method used to attach them to the frame of the blanking tool. Without either (a) drilling and pinning or (b) welding to the frame, these joggers are prone to twisting in the event of a machine jam-up or other occurrence. Drilling and pinning to the frame is time-consuming, while welding results in a permanent fixture which inhibits the machine operator from moving or replacing joggers.

Accordingly, the fixed part preferably comprises a base portion for securing to a frame of a blanking tool and at least one further portion displaced from the base portion for entering a slot in the frame. In the preferred embodiment the at least one further portion comprises a pair of wings extending at an angle from opposite edges of the base portion.

Preferably, the fixed part comprises a pair of opposite substantially parallel outer edges which lie in a plane spaced from the base portion, and wherein the sliding part comprises a pair of opposite substantially parallel turned-in edges which slidably embrace the outer edges of the fixed part.

The invention further provides a blanking tool comprising a rigid substantially rectangular frame and a plurality of joggers mounted on the inside of the frame, wherein the frame comprises a plurality of substantially straight frame members which cross one another substantially at right angles at each corner of the frame, each frame member having a longitudinal slot along its inside surface, and wherein adjacent frame members are releasably secured together at each corner of the frame by a bracket which is bolted to each adjacent frame member by a respective bolt which passes through a corresponding hole in the bracket to engage a nut slidably captured in the slot in the respective frame member.

An embodiment of the invention will now be described, by way of example, with reference to the accompanying drawings, in which:

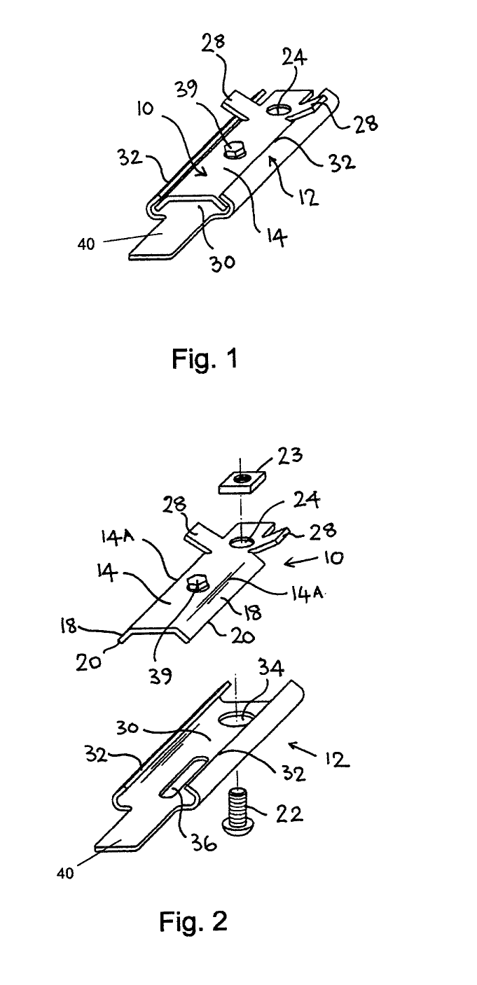

FIG. 1 is a front view of an embodiment of sliding jogger according to the invention;

FIG. 2 shows the fixed and sliding parts respectively of the jogger of FIG. 1;

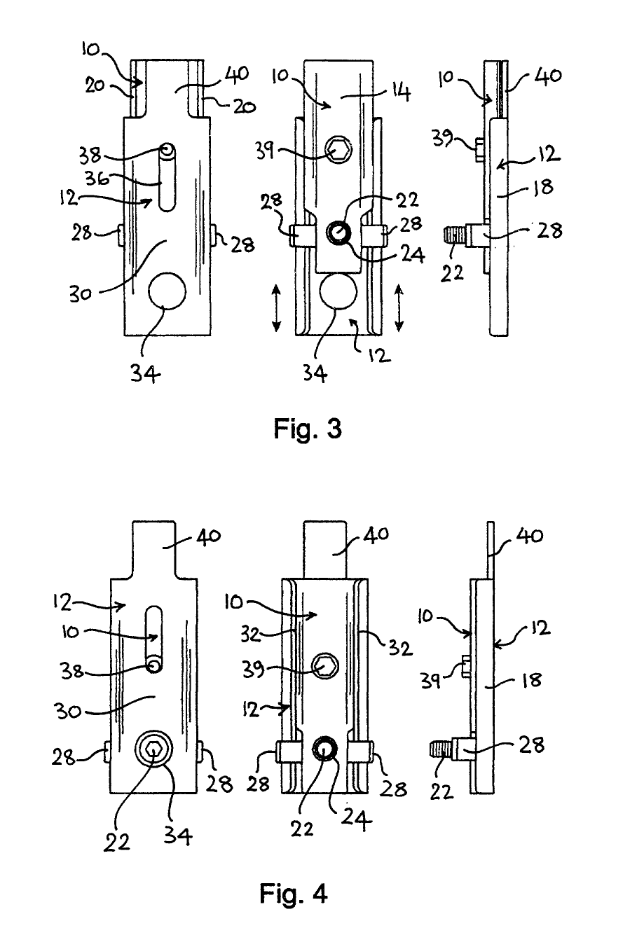

FIG. 3 shows front, back and side views of the jogger with the sliding part at the lower end of its range of movement;

FIG. 4 shows front, back and side views of the jogger with the sliding part at the upper end of its range of movement;

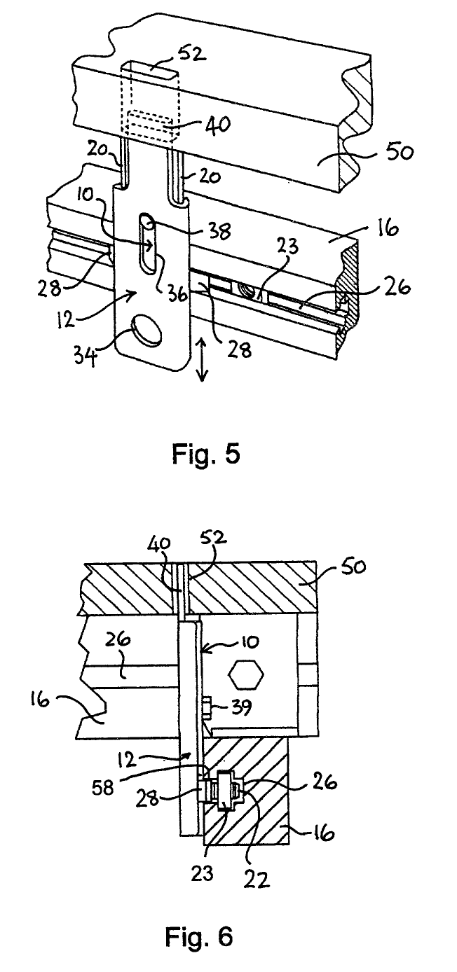

FIG. 5 is a perspective view of the jogger fixed to a support bar of a blanking tool;

FIG. 6 is a cross-sectional view of the assembly of FIG. 5;

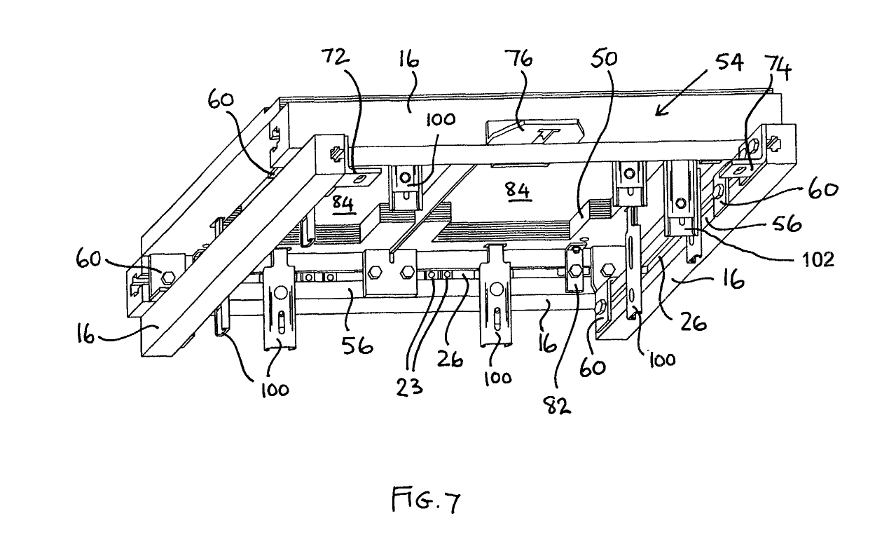

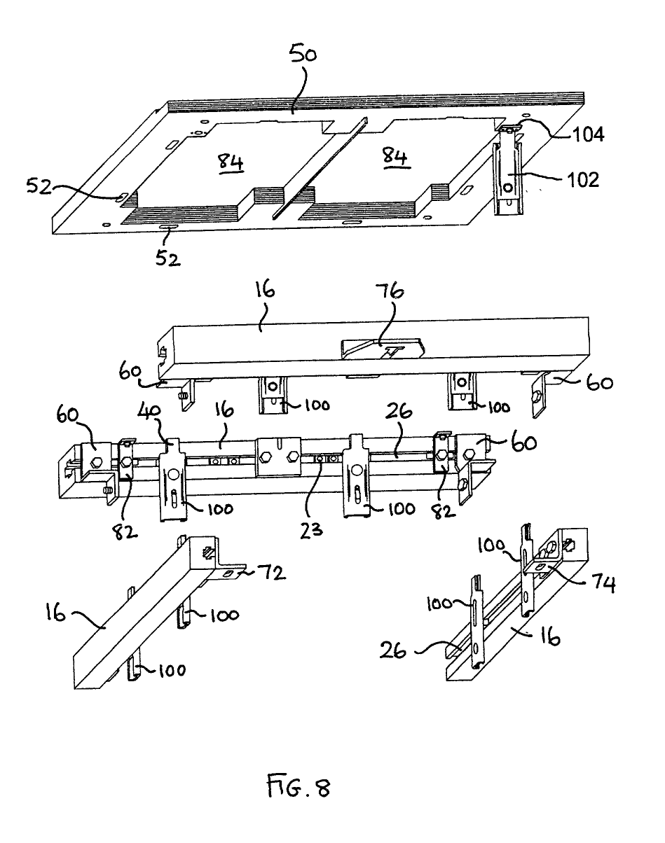

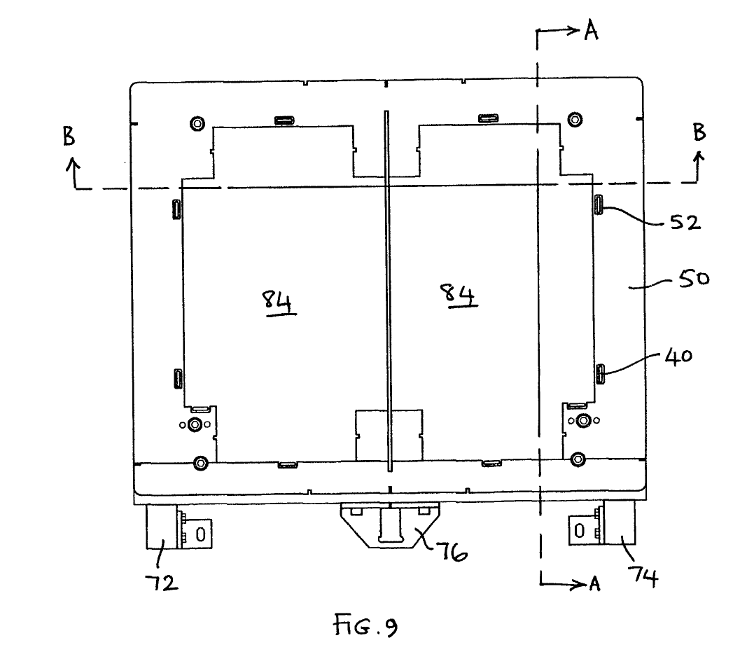

FIG. 7 is a perspective view from underneath of a blanking tool incorporating sliding joggers of FIGS. 1 to 6;

FIG. 8 is an exploded view of the components of the blanking tool of FIG. 7, again seen in perspective from underneath;

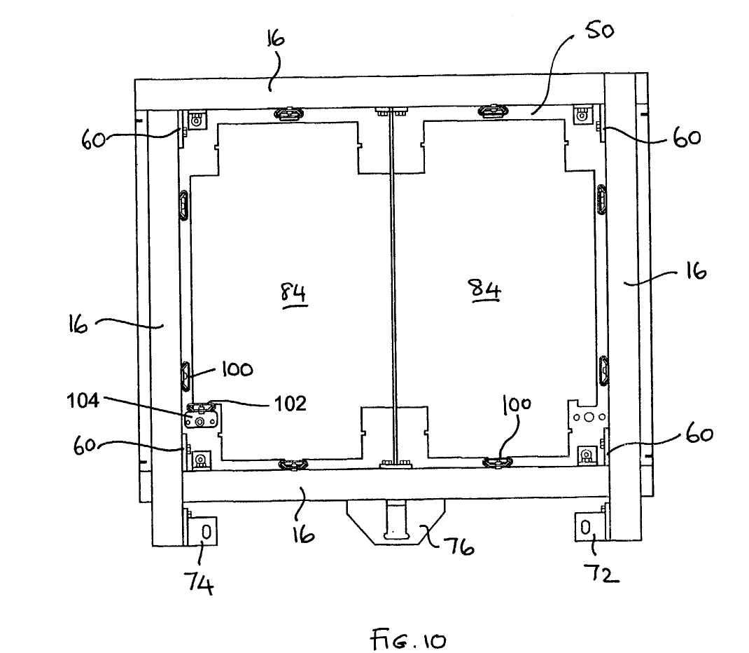

FIG. 9 is a top plan view of the blanking tool;

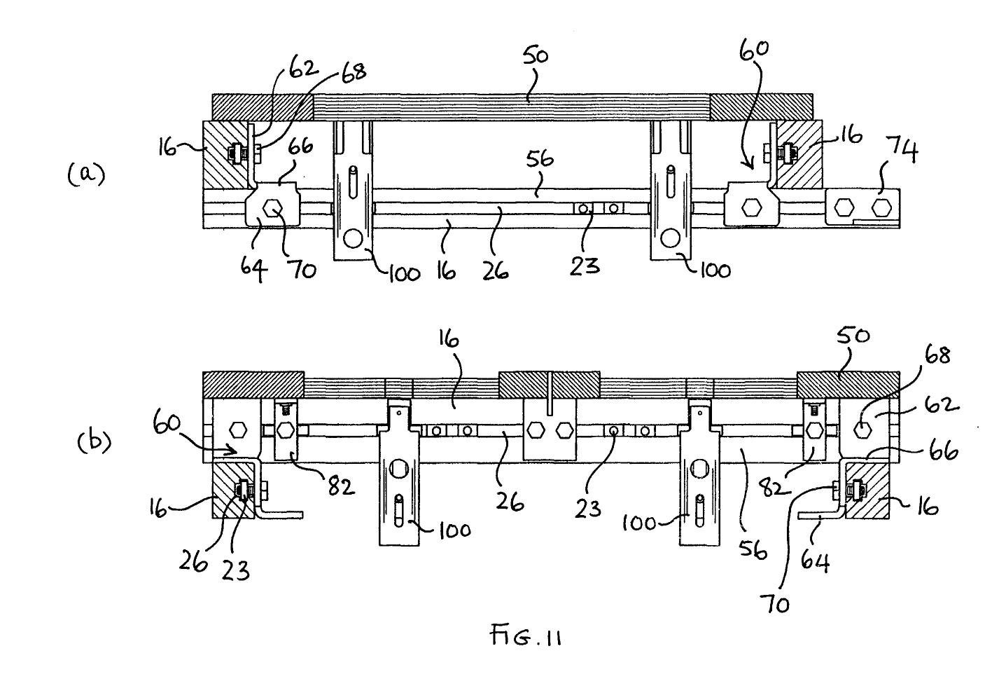

FIG. 10 is a bottom plan view of the blanking tool;

FIG. 11(a) is a cross-section of the blanking tool taken on the plane A-A of FIG. 9; and

FIG. 11(b) is a cross-section of the blanking tool taken on the plane B-B of FIG. 9.

Referring initially to FIGS. 1 to 6 of the drawings, a sliding jogger comprises fixed and sliding parts 10 and 12 respectively. Each part is manufactured by stamping a respective blank from sheet metal and bending the blank. This may be done using conventional metal stamping and bending techniques.

The fixed part 10 is substantially symmetrical about a longitudinal axis and comprises a substantially flat base portion 14 for fixing to a frame member 16, FIGS. 5 and 6, of a blanking tool to be described later. A pair of inclined walls 18 extend outwardly from opposite longitudinal edges 14A of the base portion 14 respectively, the walls 18 having substantially parallel outer edges 20 which lie in a plane spaced from and substantially parallel to the base portion 14.

The fixed part 10 is fitted to the frame member 16 by a bolt 22 which passes freely through a hole 24 in the base portion 14 and is screwed tightly into a nut 23 slidably captured in a slot 26 in the member 16. To resist twisting of the jogger in use, the base portion 14 also has a pair of wings 28, located one on either side of the hole 24, which extend outwardly from the opposite edges 14A of the base portion 14 and are bent at an angle out of the plane of the base portion 14 into the slot 26.

The sliding part 12 of the jogger, which is also substantially symmetrical about its longitudinal axis, comprises a body portion 30 having a pair of opposite substantially parallel turned-in edges 32. These edges 32 slidably embrace the respective outer edges 20 of the inclined walls 18 of the fixed part 10 such that the sliding part 12 is able to freely slide along the fixed part 10 but cannot be removed from it in a direction normal to the base portion 14.

To limit the range of travel of the sliding part 12 on the fixed part 10, to stop it sliding off in use, the body portion 30 has a slot 36 extending substantially parallel to the direction of movement of the sliding part, and the base portion 14 has an upstanding pin 38 (FIGS. 4 and 5) which enters the slot 36. The limits of travel are defined by the pin 38 meeting the opposite ends of the slot 36. The pin 38 is actually the shank of a bolt 39 which is screwed through the base portion 14 from the opposite side.

To allow access to the hole 24 in the base portion 14 the body portion 30 of the sliding part 12 has a hole 34 which is in register with the hole 24 in the base portion 14 when the sliding part 12 is at one end of its range of travel (FIGS. 1 and 4).

Referring now in addition to FIGS. 7 to 11, a blanking tool comprises a rigid rectangular frame 54 comprising four straight frame members 16. The top pair of frame members 16 (as seen in FIGS. 7 and 8) lie across and at right angles to the bottom pair so that at each of the four corners of the frame 54 an adjacent pair of frame members 16 cross one another at right angles. The inside surface 56 of each frame member 16 is substantially flat and has a slot 26 (see also FIGS. 5 and 6) extending longitudinally of the frame member. Each slot 26 has a constricted mouth 58, FIG. 6, and contains a plurality of nuts 23 captured therein such that the nuts can slide sideways along the slot but cannot be withdrawn through the mouth 58. At each of the four corners of the frame 54 the two adjacent frame members 16, crossing one another at right angles, are secured together by a respective bracket 60.

Each bracket 60 comprises two flanges 62, 64 (FIG. 11) extending in substantially vertical planes upwardly and downwardly respectively from a central horizontal plate 66, the plane containing the flange 62 being at right angles to the plane containing the flange 64. Each upper flange 62 is bolted flat against the inside surface 56 of one of the top frame members 16 by a respective bolt 68 which passes freely through a hole (not shown) in the flange 62 and is screwed tightly into one of the nuts 23 slidably captured in a slot 26. Likewise, each lower flange 64 is bolted flat against the inside surface 56 of one of the bottom frame members 16 by a respective bolt 70 which passes freely through a hole (not shown) in the flange 64 and is screwed tightly into one of the nuts 23 slidably captured in a slot 26.

By this arrangement the overall dimensions of the frame 54 can be simply adjusted by slackening the bolts 68, 70 and sliding the brackets 60 along the slots 26 until the desired frame dimensions are reached, and re-tightening the bolts. The pair of bottom frame members have further brackets 72 and 74 to allow the frame to be fixed vertically to the blanking section of the machine. This is done by placing bolts attached to the machine section through the holes in these brackets and screwing the frame securely in position. One of the top frame members has a further bracket 76 which is fixed centrally in the horizontal position and is used as a guide by the machine setter to fix the frame in the correct position in the blanking section of the machine.

The blanking tool also includes a template 50. This is essentially a plywood sub-frame which is fixed to the top of the frame 54 by brackets 82, FIG. 11(b). The template 50 has apertures 84 corresponding to the shape of the blanks to be detached from cardboard sheets, the blanks having been stamped into the sheet but not yet fully detached. The blanks therefore pass through the apertures 84 while the surrounding cardboard frame is retained on top of the template 80. This operation is known in the art.

In order to line up the detached blanks, a plurality of sliding joggers 100 are mounted around the inside of the frame 54 in the manner described with reference to FIGS. 1 to 6. Thus, the fixed part 10 of each jogger is secured by its base portion 14 flat against the flat inside surface 56 of the associated member 16 so that its outer edges 20 lie in a plane spaced inwardly of the surface 56, and the sliding part 12 mounted on the edges 20 faces inwardly of the frame 54. This manner of securing the joggers 100 allows their number and positions to be adjusted according to the dimensions of the frame and the shape of the template. In order to allow the sliding part 12 of each jogger 100 to be fully retracted upwards, the template 50 has slots 52 to accommodate the narrow upper ends 40 of the sliding parts 12.

Further joggers, such as the jogger 102, may be used on areas of the template 50 which are not situated on the outer edges of the cardboard sheet. The jogger 102 is attached directly to the plywood template by a folded tab 104 at the top of the fixed part 10 which does not therefore require the wings 28 of the joggers 100. The tab 103 has three studs attached, best seen in FIG. 10, the two outer studs being used for positive location by engaging in holes in the template and the centre stud being used to tighten the jogger 102 to the template by the use of a screw. The sliding part 12 of the jogger 102 is identical to that of the jogger 100.

The invention is not limited to the embodiment described herein which may be modified or varied without departing from the scope of the invention.

1. A sliding jogger comprising a fixed part for securing to the frame of a blanking tool and a sliding part slidable on the fixed part, wherein the two parts of the jogger are formed by stamping a respective blank from sheet metal and bending the blank.

2. A sliding jogger as claimed in claim 1, wherein the fixed part comprises a base portion for securing to the frame of the blanking tool and at least one further portion displaced from the base portion for entering a slot in the frame.

3. A sliding jogger as claimed in claim 2, wherein the at least one further portion comprises a pair of wings extending at an angle from opposite edges of the base portion.

4. A sliding jogger as claimed in claim 1, wherein the fixed part comprises a base portion for securing to the frame of the blanking tool and a pair of opposite substantially parallel outer edges which lie in a plane spaced from the base portion, and wherein the sliding part comprises a pair of opposite substantially parallel turned-in edges which slidably embrace the outer edges of the fixed part.

5. A sliding jogger as claimed in claim 2, wherein the base portion has a hole to accept a screw-threaded fixing means to secure the base portion to the frame.

6. A sliding jogger as claimed in claim 5, wherein the sliding part has a hole which is in register with the hole in the base portion in one position of the sliding part relative to the fixed part, to allow access to the hole in the base portion.

7. A sliding jogger as claimed claim 1, wherein the sliding part has a slot extending substantially parallel to its direction of movement, and wherein the fixed part has a projection which enters the slot, the range of travel of the sliding part relative to the fixed part being defined by the pin meeting the opposite ends of the slot.

8. A blanking tool comprising a rigid substantially rectangular frame and a plurality of joggers mounted on the inside of the frame, wherein the frame comprises a plurality of substantially straight frame members which cross one another substantially at right angles at each corner of the frame, each frame member having a longitudinal slot along its inside surface, and wherein adjacent frame members are releasably secured together at each corner of the frame by a bracket which is bolted to each adjacent frame member by a respective bolt which passes through a corresponding hole in the bracket to engage a nut slidably captured in the slot in the respective frame member.

9. A blanking tool as claimed in claim 8, wherein each jogger comprises a fixed part secured to a frame member and a sliding part slidable on the fixed part, and wherein the two parts of each jogger are formed by stamping a respective blank from sheet metal and bending the blank.

10. A blanking tool as claimed in claim 9, wherein the fixed part of each jogger comprises a base portion secured to a frame member and at least one further portion displaced from the base portion for entering the slot in the frame member.

11. A blanking tool as claimed in claim 9, wherein the at least one further portion comprises a pair of wings extending at an angle from opposite edges of the base portion into the slot.

12. A blanking tool as claimed in claim 9, wherein the fixed part comprises a base portion secured to the frame member and a pair of opposite substantially parallel outer edges which lie in a plane spaced inwardly of the frame member, and wherein the sliding part comprises a pair of opposite substantially parallel turned-in edges which slidably embrace the outer edges of the fixed part.

13. A blanking tool as claimed claim 12, wherein the fixed part is secured to the frame member by a bolt which passes through a hole in the base portion to engage a nut slidably captured in the slot.

14. A blanking tool as claimed in claim 13, wherein the sliding part has a hole which is in register with the hole in the base portion in one position of the sliding part relative to the fixed part, to allow access to the hole in the base portion.

15. A blanking tool as claimed claim 8, wherein the sliding part has a slot extending substantially parallel to its direction of movement, and wherein the fixed part has a projection which enters the slot, the range of travel of the sliding part relative to the fixed part being defined by the pin meeting the opposite ends of the slot.
